(19) United States
(12) Patent Application Publication
(10) Pub. No.: US 2008/0133782 A1
(43) Pub. Date: Jun. 5, 2008

(54) Reception system and method of processing interface information

(75) Inventor: Kwang Hun Kwon, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/987,276

(22) Filed: Nov. 28, 2007

(30) Foreign Application Priority Data
Dec. 1, 2006 (KR) 10-2006-0120564

(51) Int. Cl. G06F 3/00

(52) U.S. Cl. 710/19

(57) ABSTRACT

An improved reception system and a method of processing interface information are diclosed. The reception system includes a host and a card which can be detachably coupled to the host. The card makes a request for digital input/output interface status information to the host using a diagnostic function. The host collects the requested digital input/output interface status information and transmits the collected digital input/output interface status information to the card.

This application claims the benefit of Korean Patent Application No. 10-2006-0120564, filed on Dec. 1, 2006, which is hereby incorporated by reference as if fully set forth herein.

### BACKGROUND OF THE INVENTION

1. Field of the Invention

The present invention relates to a reception system capable of receiving digital broadcasts and a method of processing digital input/output interface information in the reception system.

2. Discussion of the Related Art

Among digital broadcast systems, a cable broadcast system largely includes a cable broadcast station which is a transmission side for transmitting cable broadcasts and a broadcast receiver which is a reception side for receiving the transmitted cable broadcasts. The cable broadcast station is also called a headend.

The broadcast receiver uses, for example, an open cable method in which a cable card is separated from a main body. In this case, the cable card can be detachably coupled to a main slot of the cable broadcast receiver. The cable card is also called a point-of-deployment (POD) module or a card. For example a PCMCIA card may be used.

The main body into which the cable card is inserted is also called a host. For example, the host may be a digital built-in television (TV) receiver and a digital ready TV receiver. A combination of the host and the cable card is called the broadcast receiver.

### SUMMARY OF THE INVENTION

Accordingly, the present invention is directed to a reception system and a method of processing interface information that substantially obviate one or more problems due to limitations and disadvantages of the related art.

An object of the present invention is to provide a reception system and a method of processing interface information, which are capable of allowing an external module such as a cable card to make a request for digital input/output interface status information.

Another object of the present invention is to provide a reception system and a method of processing interface information, which are capable of allowing a host of a broadcast receiver to collect digital input/output interface information according to a request of an external module.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a host in a reception system includes at least one digital input/output interface port and a controller. The digital input/output interface is a unified display interface (UDI). The controller of the host collects UDI status information associated with the UDI port according to a request of an external module.

A method of processing interface information of a host may include receiving a request for UDI status information from an external module, and collecting the UDI status information associated with at least one UDI port according to the request.

The external module may include a card which can be detachably coupled to the host. The card includes a controller for making a request for the UDI status information. The controller of the card receives the UDI status information associated with at least one UDI port transmitted from the host.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram showing a cable broadcast network including a host and a cable card according to an embodiment of the present invention;

FIG. 2 is a conceptual diagram of an example of a process of making a request for diagnostic information and responding thereto between the cable card and the host according to the present invention;

FIGS. 3A and 3B are views showing examples of allocating a diagnostic ID for diagnosis of a digital input/output interface status according to the present invention;

FIGS. 4A and 4B are views showing examples of syntax structure for collecting and transmitting corresponding diagnostic information when receiving a diagnostic request in an S-mode;

FIGS. 5A and 5B are views showing examples of syntax structure for collecting and transmitting corresponding diagnostic information when receiving a diagnostic request in an M-mode;

FIG. 6 is a view showing an example of a diagnostic syntax structure for digital input/output interface status information according to the present invention;

FIG. 7 is a flowchart illustrating a process of making a request for the digital input/output interface status information and responding thereto using a diagnostic function according to the embodiment of the present invention; and

FIG. 8 is a block diagram showing a reception system capable of receiving cable broadcasts according to the embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Additional advantages, objects, and features of the invention will be more readily apparent from consideration of the following detailed description relating to the accompanying drawings.

The configuration and operation of the embodiments of the present invention will be described with reference to the accompanying drawings. The configuration and operation of the present invention shown in the drawings and described hereinafter will be described in at least one embodiment, without limiting the spirit and scope of the present invention.

In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

Among digital input/output interfaces, a unified display interface (UDI) is an interface which can freely connect all display devices including a personal computer (PC) or a digital TV receiver using a single connector. The UDI is likely to replace the VGA standard for connecting a PC to a monitor in the existing analog method and can be compatible with a digital visual interface (DVI) or a high-definition multimedia interface (HDMI). The UDI connects all display devices such as a monitor and a HDTV receiver using a single connector so as to reproduce HD contents and support a high-bandwidth digital content protection (HDCP) technology which is widely used in the HDTV receiver in order to prevent unauthorized duplication. Therefore, since a PC having the UDI mounted therein is connected to a monitor as well as a display device having a HDMI mounted therein, HD contents can be stably reproduced.

In the present invention, a broadcast receiver collects link status information of the UDI according to the request of an external module and provides the collected status information of the UDI to the external module.

For example, if the broadcast receiver is a receiver for receiving cable broadcasts, the external module may be a cable card.

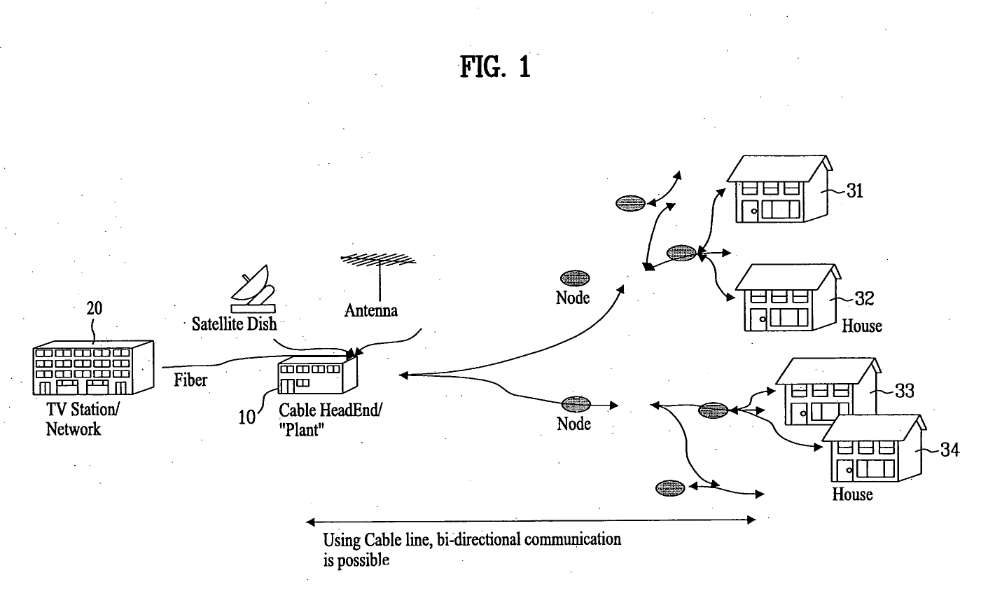

FIG. 1 is a conceptual diagram showing a cable broadcast network between a broadcast receiver and a headend according to an embodiment of the present invention. The headend/plant 10 receives a broadcast signal via various communication networks from a television broadcast station 20 and transmits the broadcast signal to broadcast receivers 31 to 34 via a cable network including a node. The broadcast receivers and the headend/plant transmit/receive data to/from each other via a cable network infrastructure for bi-directionally transmitting data.

At this time, in one embodiment, each of the broadcast receivers 31 to 34 includes a host and a cable card. The cable card can be detachably coupled to the host.

In one embodiment, the cable card in the broadcast receiver makes a request for the status information of the UDI to the host, and the host checks the link status information of the UDI and transmits the link status information of the UDI to the cable card according to the request.

In one embodiment, the cable card makes the request for the status information of the UDI and the host responds thereto, using a diagnostic function.

That is, the cable broadcast standard has a diagnostic function for monitoring the statuses of the host. The diagnostic function checks an operation status of the host and a link status of a peripheral device.

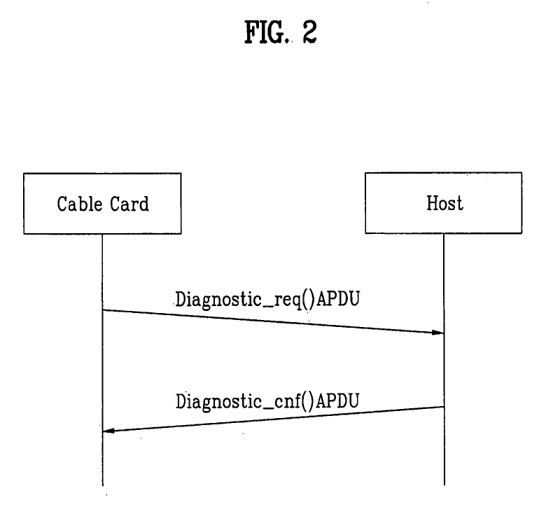

FIG. 2 is a conceptual diagram of a process of diagnosing the status of the host when the cable card receives a diagnostic command for the status of the host from the headend or a user.

The cable card receives the diagnostic command for the status of the host from the headend or the user and transmits the diagnostic command to the host according to a predetermined protocol. The host which receives the diagnostic command from the cable card collects diagnostic information corresponding to the diagnostic command and the collected diagnostic information to the cable card according to a predetermined protocol.

At this time, the predetermined protocol may be a generic diagnostic protocol in an open cable. The generic diagnostic protocol is defined such that a variety of status information of devices linked to a variety of system information of the host is monitored in a local place (user) or a remote place (headend) in real time. According to this protocol, the cable card transmits the diagnostic command to the host by a diagnostic request protocol and the host transmits a response for the diagnostic command to the cable card by a diagnostic confirmation protocol.

That is, the diagnostic request is included in Diagnostic_req( )APDU (application protocol data unit) and is transmitted from the cable card to the host and the diagnostic response is included in Diagnostic_cnf( )APDU and is transmitted from the host to the cable card. The APDU is the unit of data exchanged between equivalent application entities in an application layer. For example, on a data channel which is one of CPU interfaces of the cable card and the host, the diagnostic information is requested through the exchange of Diagnostic_req( )APDU and Diagnostic_cnf( )APDU and the collected diagnostic information is exchanged according to the request.

At this time, when the cable card makes a request for diagnosis, the host should check the type of the requested diagnosis in order to collect the diagnostic information corresponding thereto and report the collected diagnostic information to the cable card.

Accordingly, in the cable broadcast standard, the types of the diagnoses which can be requested to the host are defined and identifications (IDs) are allocated to the diagnoses.

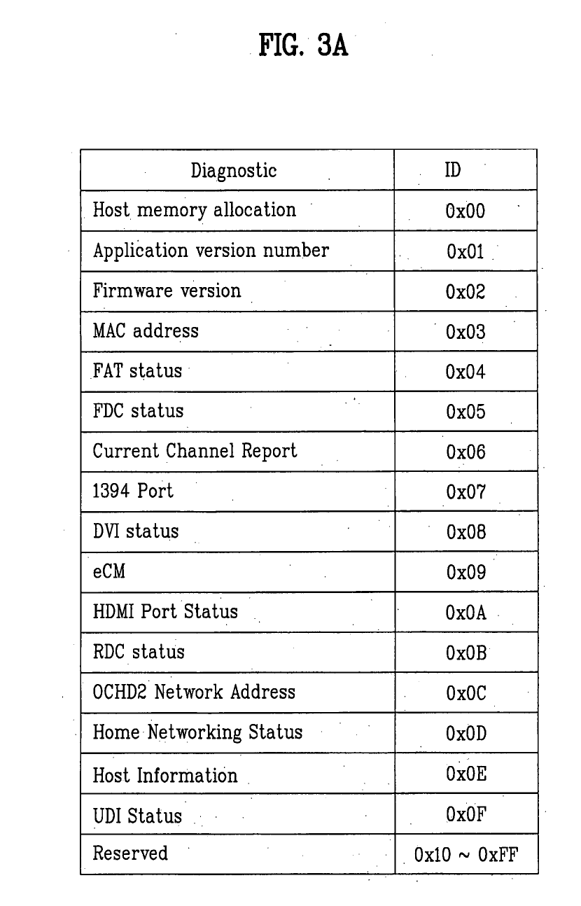

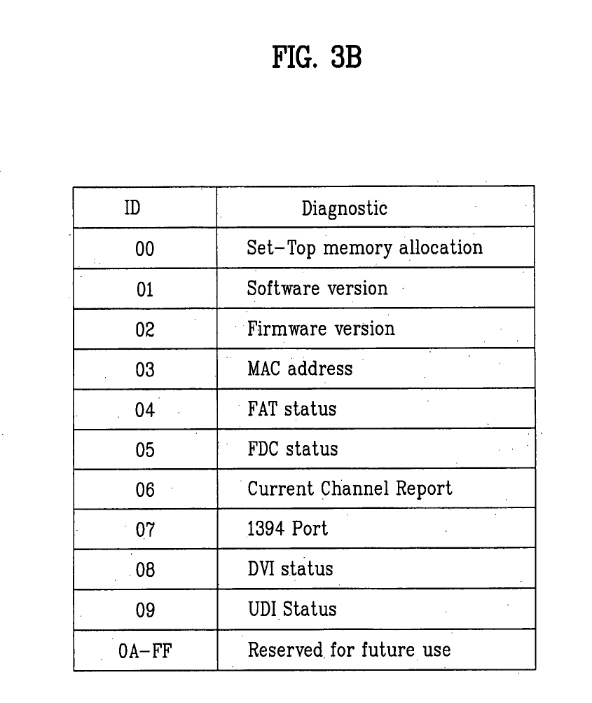

In one embodiment of the present invention, in a format in which the diagnostic types and the IDs are allocated as shown in FIG. 3A, 0x0F is allocated as the ID for diagnosing the UDI status. That is, if the diagnostic request is transmitted from the cable card to the host and the diagnostic ID is 0x0F, the host collects the status information of the UDI and reports the collected status information of the UDI to the cable card.

At this time, the allocation of 0x0F as the ID for diagnosing the UDI status is only exemplary. Any one of 0x0F to 0xFF may be allocated as the diagnostic ID of the UDI status or any one of diagnostic IDs which are already used may be allocated as the diagnostic ID of the UDI status.

Alternatively, in a format in which the diagnostic types and the IDs are allocated as shown in FIG. 3B, 0x09 is allocated as the ID for diagnosing the UDI status. Similarly, the allocation of 0x09 as the ID for diagnosing the UDI status is only exemplary. Any one of 0x09 to 0xFF may be allocated as the diagnostic ID of the UDI status or any one of diagnostic IDs which are already used may be allocated as the diagnostic ID of the UDI status.

Meanwhile, an interface between the cable card and the host is of a single stream cable card interface type and a multistream cable card interface type.

The single stream cable card interface allows the cable card to process a single broadcast stream and allows the host to decode the single broadcast stream. The multistream cable card interface allows the cable card to process a plurality of multiplexed broadcast streams and allows the host to decode the plurality of broadcast streams.

Hereinafter, a case where the cable card processes the single stream (hereinafter, referred to as an “S-mode”) and a case where the cable card processes the multistream (hereinafter, referred to as an “M-mode”) will be described as the technical spirit of the present invention.

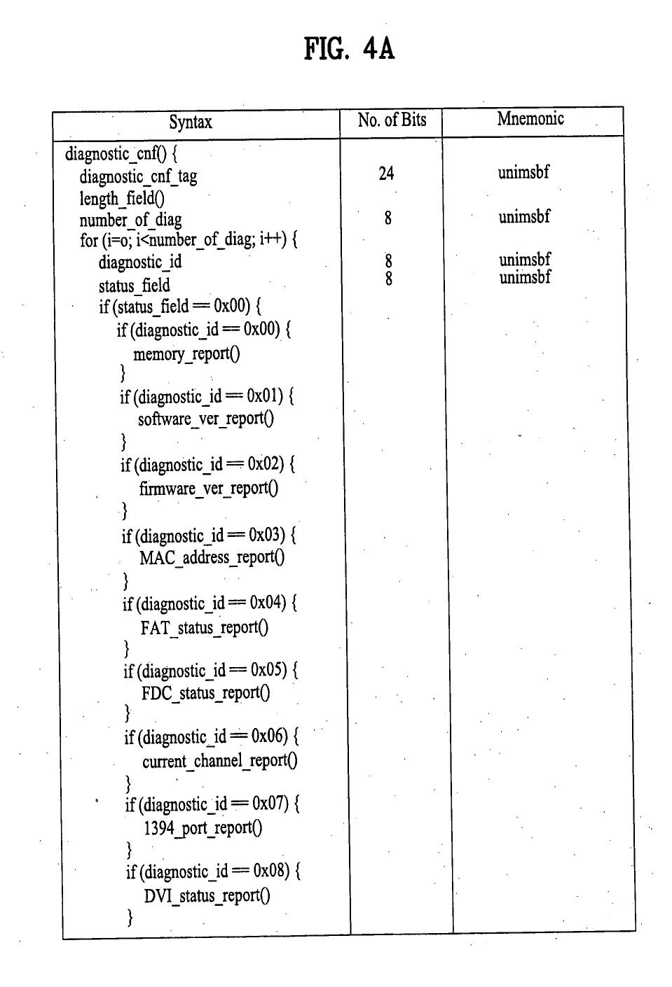

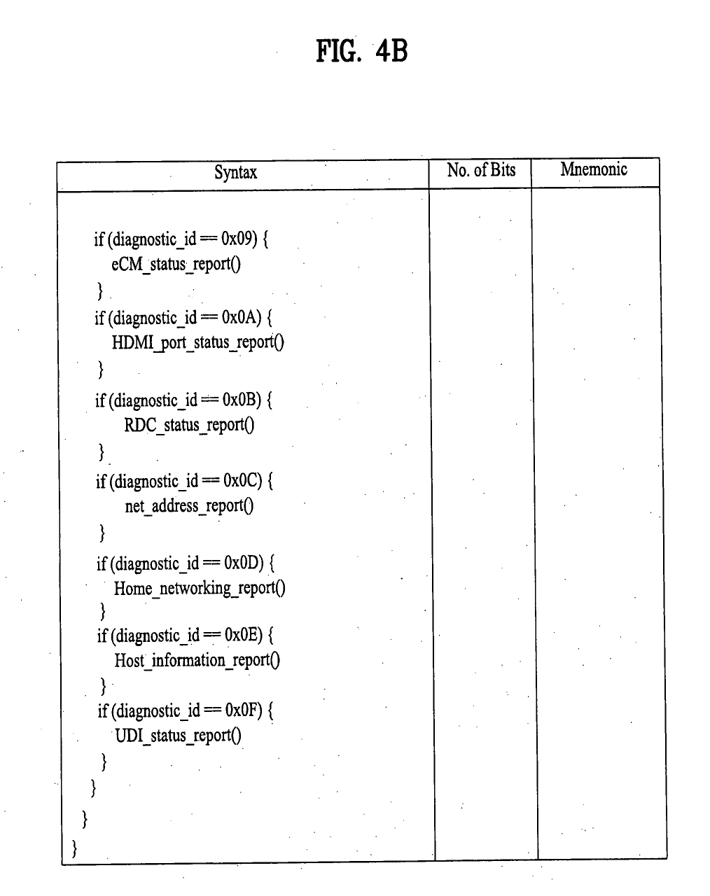

FIGS. 4A and 4B are views showing examples of a syntax structure of an S-mode diagnostic confirmation protocol for transmitting the diagnostic result Diagnostic_cnf( )APDU from the host to the cable card when the cable card transmits the diagnostic request Diagnostic_req( )APDU to the host according to the format in which the diagnostic types and the IDs are allocated as shown in FIG. 3A.

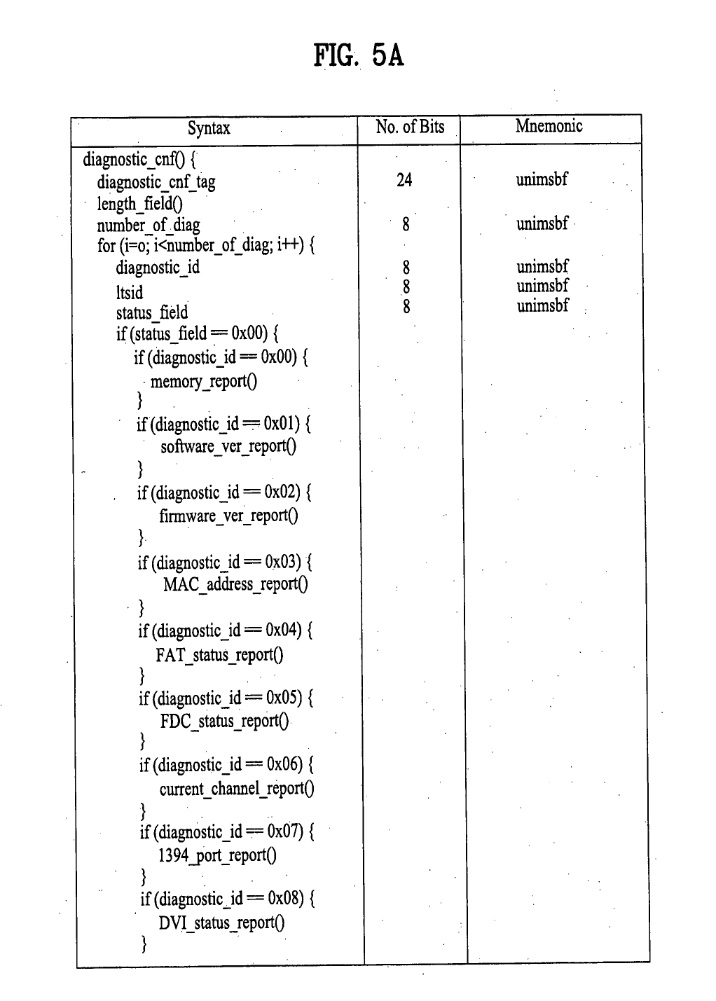

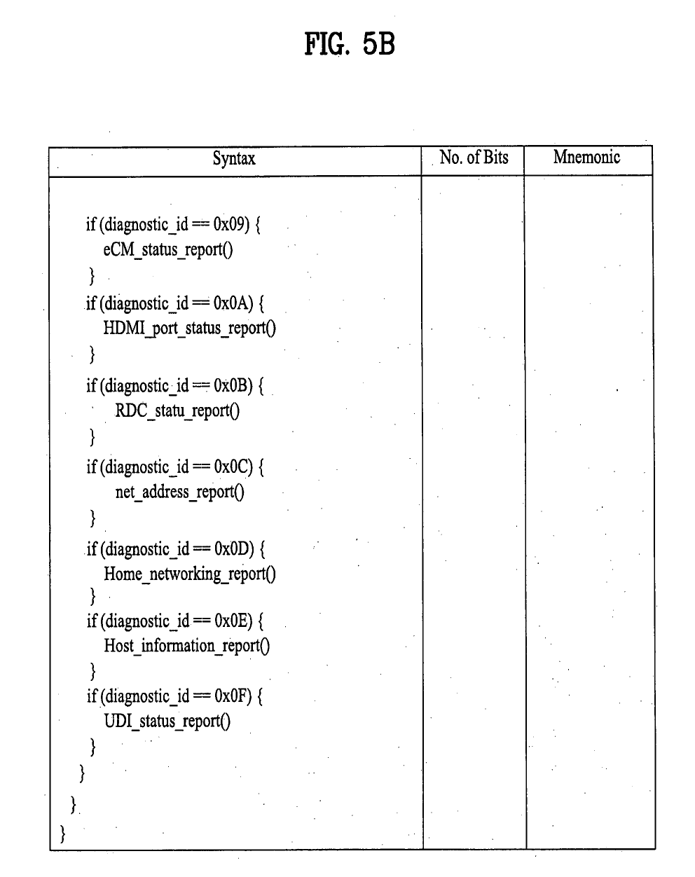

FIGS. 5A and 5B are views showing examples of a syntax structure of an M-mode diagnostic confirmation protocol for transmitting the diagnostic result Diagnostic_cnf( )APDU from the host to the cable card when the cable card transmits the diagnostic request Diagnostic_req( )APDU to the host according to the format in which the diagnostic types and the IDs are allocated as shown in FIG. 3A.

The syntax structures shown in FIGS. 5A and 5B are different from the syntax structures shown in FIGS. 4A and 4B in that IDs Itsid of the streams are declared with respect to the plurality of multiplexed streams.

As shown in FIGS. 4A, 4B, 5A and 5B, the host collects the status information of the UDI, includes the collected status information of the UDI UDI_status_report( ) in Diagnostic_cnf( )APDU, and transmits Diagnostic_cnf( )APDU to the cable card, if a status field value status_field is 0x00 and a diagnostic ID Diagnostic_id is 0x0F.

For example, if the host has a UDI port, the host responds to a request for the UDI status even when a DVI or a HDMI device is connected to the UDI port via a UDI connector. In contrast, if the host does not have a UDI port, the host does not respond to a request for the UDI status even when a DVI or a HDMI device is connected to the UDI port via a UDI connector.

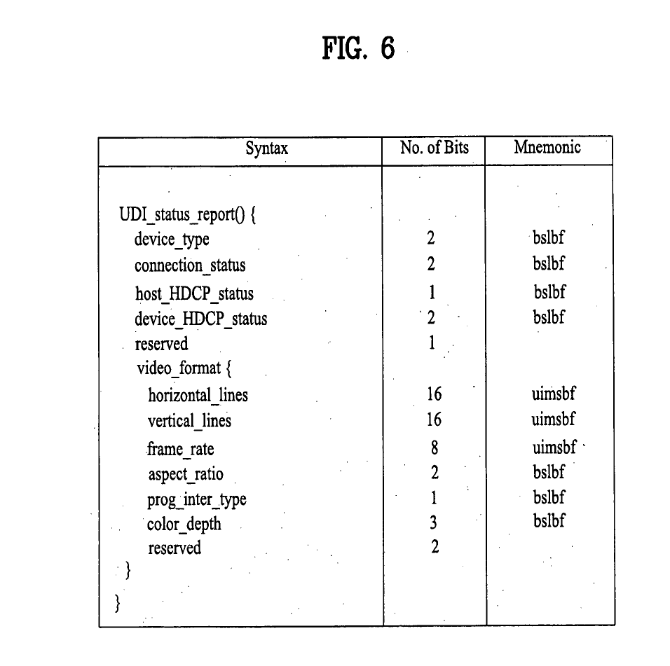

FIG. 6 is a view showing an example of a syntax structure of UDI_status_report( ) according to the present invention, which shows information generated when the host checks the UDI status according to the diagnostic request for the UDI status of the cable card.

The UDI_status_report( ) syntax shown in FIG. 6 may include at least one of a device_type field, a connection_status field, a host_HDCP_status field, a device_HDCP_status field and a video_format field.

The device_type field is, for example, allocated with two bits and indicates whether a device connected to the UDI port via the UDI connector is a DVI, a HDMI or a UDI.

For example, it is indicated that the device connected to the UDI port is the DVI if the value of the device_type field is 00b, it is indicated that the device connected to the UDI port is the HDMI if the value of the device_type field is 01b, and it is indicated that the device connected to the UDI port is the UDI if the value of the device_type field is 10b.

The connection_status field is, for example, allocated with two bits and indicates whether a connection exists on the UDI port. It is indicated that the connection does not exist if the value of the connection_status field is 00b, it is indicated that a device without a repeater is connected if the value of the connection_status field is 01b, and it is indicated that a device with a repeater is connected if the value of the connection_status field is 10b. Here, the repeater may be, for example, an A/V receiver, and a device such as a set top box (STB) or a digital versatile disc (DVD) player may be connected to the repeater.

The host_HDCP_status field is, for example, allocated with one bit and indicates if HDCP (high-bandwidth digital content protection; copyright protection standard of a duplication preventing function) is enabled on the UDI link. For example, it is indicated that the HDCP is not enabled if the value of the host_HDCP_status field is 0b and it is indicated that the HDCP is enabled if the value of the host_HDCP_status field is 1b.

The device_HDCP_status field is, for example, allocated with two bits and indicates the HDCP status of a peripheral device connected to the UDI port of the host via the UDI connector. For example, it is indicated that the HDCP device is not present if the value of the device_HDCP_status field is 00b, it is indicated that the device is a compliant HDCP device if the value of the device_HDCP status field is 01b, and it is indicated that the device is a revoked HDCP device if the value of the device_HDCP_status field is 10b. That is, the device_HDCP status field checks the HDCP status when the STB, the DVD player or the like is connected to a digital television (DTV) receiver via the UDI connector. At this time, if the STB or the DVD player normally obtains a key Ri of the HDCP from the DTV receiver, a normal operation is performed while outputting a video/audio. This case is called the compliant HDCP. Then, the value of the device_HDCP_status field becomes 01b. In contrast, if the STB or the DVD player does not normally obtain a key Ri of the HDCP from the DTV receiver, the DVD player mutes a screen or white noise. This case is called the revoked HDCP. Then, the value of the device_HDCP_status field becomes 10b.

The video_format field includes at least one of a horizontal_lines field, a vertical_lines field, a frame_rate field, an aspect_ratio field, a prog_inter_type field and a color_depth field and indicates a current video format utilized on the UDI port.

The horizontal_lines field is, for example, allocated with 16 bits and indicates the number of horizontal lines associated with the video format on the UDI link.

The vertical_lines field is, for example, allocated with 16 bits and indicates the number of vertical lines associated with the video format on the UDI link.

The frame_rate field is, for example, allocated with 8 bits and indicates the frame rate associated with the video format on the UDI link as shown in Table 1.

TABLE 1

| Frame Rate Code | Frame Rate |
|---|---|
| 01 | 23.976 Hz |
| 02 | 24 Hz |
| 04 | 20.97 Hz |
| 05 | 30 Hz |
| 07 | 59.94 Hz |
| 08 | 60 Hz |

The aspect_ratio field is, for example, allocated with two bits and indicates the aspect ratio associated with the video format on the UDI link as shown in Table 2.

TABLE 2

| Bit Value | Video Format |
|---|---|
| 00 | 4:3 |
| 01 | 16:9 |
| 10 | Reserved |
| 11 | Reserved |

The prog_inter_type field is, for example, allocated with one bit and indicates if the video is either progressive or interlaced on the UDI link. For example, it is indicated that the video scan method is progressive if the value of the prog_inter_type field is 0b and it is indicated that the video scan method is interlaced if the value of the prog_inter_type field is 1b.

The color_depth field is, for example, allocated with three bits and indicates the color depth on the UDI link.

That is, when the cable card transmits the diagnostic request Diagnostic_req( )APDU for checking and reporting the UDI status to the host, the host checks the UDI status, includes the checked result, that is, the UDI_status_report( ) syntax, in the diagnostic response Diagnostic_cnf( )APDU, and transmits the diagnostic response Diagnostic_cnf( )APDU to the cable card.

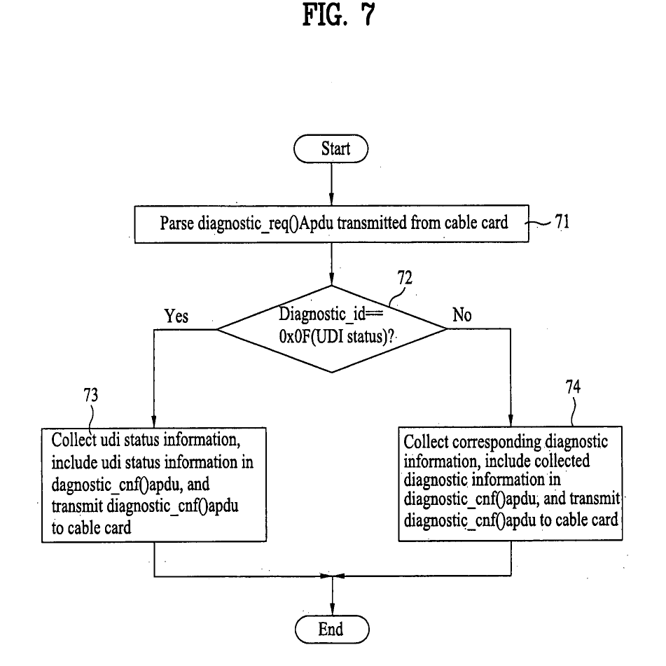

FIG. 7 is a flowchart illustrating the process. The host parses Diagnostic_req( )APDU transmitted from the cable card (step 71) and determines whether the diagnostic ID is the request for the UDI status, for example, 0x0F (step 72).

In the step 72, if the diagnostic ID is 0x0F, it is determined that the diagnostic request for checking the UDI status is received. Accordingly, the host collects the UDI status information UDI_status_report( ) as shown in FIG. 6, includes the collected UDI status information UDI_status_report( ) in the diagnostic response Dignostic_cnf( )APDU, and transmits the diagnostic response Diagnostic_cnf( )APDU to the cable card (step 73). If the diagnostic ID is not 0x0F, corresponding diagnostic information is collected, the collected diagnostic information is included in the diagnostic response Diagnostic_cnf( )APDU, and the diagnostic response Diagnostic_cnf( )APDU is transmitted to the cable card (step 74).

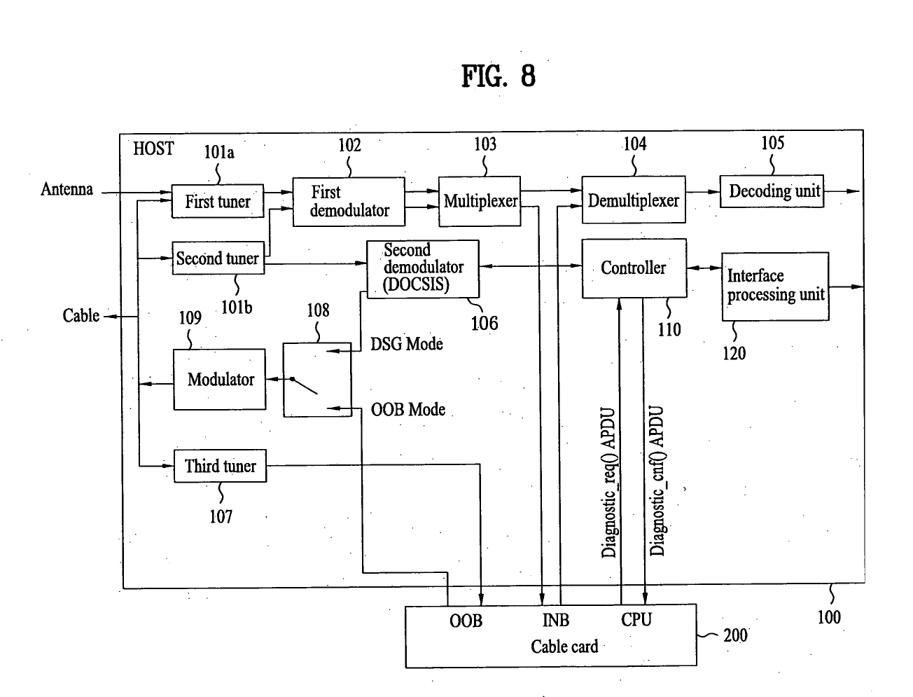

FIG. 8 is a block diagram showing a broadcast receiver according to an embodiment of the present invention, which includes a host 100 and a cable card 200 which can be detachably coupled to the host.

The host 100 may receive only a cable broadcast signal or may receive at least one of a terrestrial broadcast signal, a cable broadcast signal and a satellite broadcast signal. In the embodiment, the host 100 can receive at least one of the cable broadcast signal, the terrestrial broadcast signal and the satellite broadcast signal.

Meanwhile, a bi-directional communication method between a cable broadcast receiver and a headend includes two modes: an out-of-band (OOB) mode and a Data Over Cable Service Interface Specification (DOCSIS) settop gateway (DSG) mode. Accordingly, a viewer can select and view a desired program through the host using any one of the two modes. Alternatively, the viewer can directly participate in a broadcast program or select and view necessary information. Alternatively, a data broadcast service may be provided through the OOB mode and/or the DSG mode.

The OOB method is a mode that may be defined for transmission between a cable broadcast station (headend) and Intersec equipment in a set top box. In contrast, the DSG mode is a mode defined for transmission between a cable modem control system in a cable broadcast station and a DOCSIS-based cable modem in a set top box. At this time, in the DOCSIS, data can be transmitted using a cable modem.

The broadcast receiver shown in FIG. 8 uses a hybrid OOB/DSG mode.

In the broadcast receiver shown in FIG. 8, the host 100 may include a first tuner 101a, a second tuner 101b, a demodulator 102, a multiplexer 103, a demultiplexer 104, a decoding unit 105, a second demodulator (DOCSIS) 106, a third tuner 107, a switching unit 108, a modulator 109, a controller 110, and an interface processing unit 120.

The cable card 200 is any one of a single card (S-card) which can process a single stream and a multi card (M-card) which can process multistreams.

The first tuner 101a may be tuned to a specific channel frequency to select a corresponding broadcast among terrestrial Audio/Video (A/V) broadcasts received through an antenna or cable A/V broadcasts received in-band through a cable and may output the selected broadcast signal to the first demodulator 102.

Terrestrial and cable broadcasts use different transmission schemes. The first demodulator 102 may perform different demodulation processes for signals of different demodulation schemes. If terrestrial A/V broadcasts are transmitted after being modulated according to a vestigial sideband modulation (VSB) scheme and cable A/V broadcasts are transmitted after being modulated according to a Quadrature Amplitude Modulation (QAM) scheme, the first demodulator 102 may demodulate a signal selected by the first tuner 101a according to the VSB scheme or the QAM scheme.

The signals demodulated by the first demodulator 102 are output through the multiplexer 103 in the form of a stream. At this time, if a plurality of in-band tuners which can receive the cable A/V broadcasts exist, multistreams, which are demodulated by demodulators after different channels are simultaneously tuned by the in-band tuners, are multiplexed by the multiplexer 103 and are output.

If the signals demodulated by the first demodulator 102 are terrestrial broadcast streams, the demodulated streams are output to the demultiplexer 104 via the multiplexer 103. In contrast, if the signals demodulated by the first demodulator 102 are cable broadcast streams, the demodulated streams are output to the demultiplexer 104 via the multiplexer 103 and the cable card 200 mounted in a slot. The cable card 200 may include a conditional access (CA) system, for duplication prevention of higher value-added broadcast contents and conditional access.

That is, if the single stream or the multistreams of the cable broadcast output from the multiplexer 103 is/are scrambled, the cable card 200 descrambles the cable broadcast streams and outputs the descrambled cable broadcast streams to the demultiplexer 104. If the cable card 200 is not mounted in the host 100, the single stream or the multistreams of the cable broadcast demodulated by the demodulator 102 is/are output to the demultiplexer 104. In this case, the scrambled cable broadcasts are not descrambled and thus the user cannot normally view the cable broadcasts.

The demultiplexer 104 may receive and separate multiplexed broadcast steams into an audio stream, a video stream and a data stream and outputs the audio stream, the video stream and the data stream to decoders in the decoding unit 105. The decoding unit 105 may include an audio decoder, a video decoder and a data decoder.

The second tuner 101b may be tuned to a specific channel frequency to select a corresponding broadcast among data broadcasts, which are received through the cable according to the DSG mode, and may output the selected broadcast signal to the second demodulator 106. The second demodulator 106 may demodulate a data broadcast of the DSG mode and may output the demodulated broadcast signal to the controller 110.

The third tuner 107 may be tuned to a specific channel frequency to select a corresponding broadcast among downstream data broadcasts, which are received through the cable according to the OOB mode, and may output the selected channel signal to the cable card 200.

When bidirectional communication is possible between the headend and the cable broadcast receiver, upstream information, which contains, for example, a pay program request and diagnostic information of the host, transmitted from the cable broadcast receiver to the headend may be transmitted according to the OOB or DSG mode. In the embodiment of the present invention, the cable broadcast receiver may include the switching unit 108 which makes it possible to select one of the above modes for data transmission.

In the OOB mode, user information or system diagnostic information is output to the modulator 109 through the cable card 200 and the switching unit 108, and the modulator 109 may modulate the output signal using quadrature phase shift keying (QPSK) modulation or the like and may transmit it to the headend through the cable. When broadcast information of the user may be transmitted in the DSG mode, the broadcast information may be output to the modulator 109 through the controller 110 and the switching unit 108, and the modulator 109 may modulate the output signal using quadrature amplitude (QAM)-16 modulation or the like and may transmit it to the headend through the cable.

Meanwhile, a controller (CPU) of the cable card 200 transmits the diagnostic request Diagnostic_req( )APDU including an ID to be diagnosed to the controller 110 of the host 100. Then, the controller 110 of the host determines whether the diagnostic ID requested by the cable card 200 is 0x0F.

If it is determined that the diagnostic ID is not 0x0F, then the diagnostic information corresponding to the diagnostic ID is collected and the diagnostic response Diagnostic_cnf( )APDU including the collected diagnostic information is transmitted to the cable card 200.

If it is determined that the diagnostic ID is 0x0F, the UDI link status is checked, the UDI status information is generated, the generated UDI status information is included in the diagnostic response Diagnostic_cnf( )APDU, and the diagnostic response Diagnostic_cnf( )APDU is transmitted to the cable card 200.

At this time, the collection and transmission of the UDI status information may be performed by the controller 110 or by the interface processing unit 120 under the control of the controller 110. For example, if the diagnostic ID is 0x0F, the interface processing unit 120 checks the UDI link status under the control of the controller 110, generates the UDI status information as shown in FIG. 6, and outputs the generated UDI status information to the controller 110. Then, the controller 110 includes the received UDI status information in the diagnostic response Diagnostic_cnf( )APDU and transmits the diagnostic response Diagnostic_cnf( )APDU to the cable card 200.

The operations of the controller 110 and the interface processing unit 120 may be any one of hardware, firmware, middleware and software or a combination of at least two thereof. Alternatively, the controller 110 may function as the interface processing unit 120. In this case, the interface processing unit 120 may be omitted.

The generic diagnostic protocol described up to now is an example of a transmission standard for embodying the present invention and the technical spirit of the present invention is not limited. In the present invention, if the UDI status information is transmitted using the diagnostic information transmission standard defined in various standards of the cable broadcasts, it is possible to obtain compatibility for cable broadcast receivers and diagnostic information transmission methods using the standards. Accordingly, the transmission of the status diagnostic information using the generic diagnostic protocol may become a usable example.

In the present invention, the diagnostic function used for requesting the UDI status information and responding thereto is applicable to a bi-directional digital broadcast system such as terrestrial, satellite and IPTV in addition to the cable. At this time, in the satellite, a smart card may be used instead of the cable card. In this case, an interface module interfacing with an external device may be mounted within or outside the system.

The existing hardware CAS may not be separately mounted in the cable card or the host, for example, a set top box or an integral type TV receiver of a subscriber. That is, a software CAS provided by a provider may be downloaded to the set top box or the integral type TV receiver of the subscriber such that the existing CAS function can be performed.

As an example of a method of downloading the software CAS, when a security processor which is previously built in the host is connected to a network, a CA image may be automatically downloaded from the headend and may be performed.

According to the present invention, the cable card can make for a request for checking and reporting the UDI status to the host and the host can check the UDI status and report the checked result to the cable card.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of processing interface information of a reception system, the method comprising:
receiving a request for unified display interface (UDI) status information from an external module;
collecting the UDI status information associated with at least one UDI port according to the request; and
transmitting the collected UDI status information to the external module.

2. The method of claim 1, wherein the UDI status information includes at least one of device type information indicating the type of a device connected to the UDI port, connection status information indicating whether a connection exists on the UDI port, and current video format information utilized on the UDI port.

3. The method of claim 2, wherein the video format information includes at least one of the number of horizontal lines, the number of vertical lines, a frame rate, an aspect ratio, a scan type and a color depth, all of which are associated with a video format on a UDI link.

4. The method of claim 2, wherein the UDI status information further includes at least one of information indicating whether high-bandwidth digital content protection (HDCP) is enabled on the UDI link and information indicating a HDCP status of the connected device.

5. A reception system comprising a host,
wherein the host includes:
at least one unified display interface (UDI) port; and
a controller which collects UDI status information associated with the UDI port according to a request for UDI status information.

6. The reception system of claim 5, wherein the controller receives the request for the UDI status information transmitted from a card which can be detachably coupled to the host.

7. The reception system of claim 6, wherein the controller transmits the collected UDI status information to the card.

8. The reception system of claim 6, wherein the controller communicates with the card using a generic diagnostic protocol.

9. The reception system of claim 5, wherein the controller configures the UDI status information including at least one of device type information indicating the type of a device connected to the UDI port, connection status information indicating whether a connection exists on the UDI port, and current video format information utilized on the UDI port.

10. The reception system of claim 9, wherein the video format information includes at least one of the number of horizontal lines, the number of vertical lines, a frame rate, an aspect ratio, a scan type and a color depth, all of which are associated with a video format on a UDI link.

11. The reception system of claim 9, wherein the controller configures the UDI status information which further includes at least one of information indicating whether high-bandwidth digital content protection (HDCP) is enabled on the UDI link and information indicating a HDCP status of the connected device.

12. A reception system comprising:
a host which includes at least one UDI port and receives contents transmitted from a device connected to the UDI port; and
an external module which can be detachably coupled to the host,
wherein the external module includes a controller which transmits a request for UDI status information to the host and receives the UDI status information associated with the at least one UDI port transmitted from the host in response to the request.

13. The reception system of claim 12, wherein the host collects the UDI status information associated with the at least one UDI port and transmits the collected UDI status information to the external module according to the request for the UDI status information.

14. The reception system of claim 12, wherein the UDI status information includes at least one of device type information indicating the type of a device connected to the UDI port, connection status information indicating whether a connection exists on the UDI port, and current video format information utilized on the UDI port.

15. The reception system of claim 14, wherein the video format information includes at least one of the number of horizontal lines, the number of vertical lines, a frame rate, an aspect ratio, a scan type and a color depth, all of which are associated with a video format on a UDI link.

16. The reception system of claim 14, wherein the UDI status information further includes at least one of information indicating whether high-bandwidth digital content protection (HDCP) is enabled on the UDI link and information indicating a HDCP status of the connected device.

17. The reception system of claim 12, wherein the host and the external module communicate with each other using a generic diagnostic protocol.

18. The reception system of claim 17, wherein the host collects the UDI status information associated with the at least one UDI port if an identification (ID) included in a diagnostic request transmitted from the external module is a diagnostic ID allocated so as to identify the request for the UDI status information.

19. The reception system of claim 12, wherein the external module includes a card.
